(19) United States
(12) Patent Application Publication
(10) Pub. No.: US 2017/0278136 A1
(43) Pub. Date: Sep. 28, 2017

(54) COMPUTERIZED SYSTEM FOR PROCESSING READABLE INDICIA FOR TARGETED DATA EXTRACTION AND INTERACTION MANIPULATION

(71) Applicant: John R. Johnson, Charlotte, NC (US)

(72) Inventor: John R. Johnson, Charlotte, NC (US)

(21) Appl. No.: 15/439,380

(22) Filed: Feb. 22, 2017

Related U.S. Application Data
(63) Continuation-in-part of application No. 14/060,229, filed on Oct. 22, 2013, now abandoned.

(51) Int. Cl. G06Q 30/02; G06F 3/0482

(52) U.S. Cl. CPC G06Q 30/0257; G06F 3/0482; G06Q 30/0267; H04M 1/72522

(57) ABSTRACT

Embodiments of the invention are directed to systems, methods and computer program products for processing readable indicia for targeted data extraction and interaction manipulation. The invention receives an alternative interaction request from a user over a network that indicates the user's interest in a resource provided by a first entity at a first entity location. The invention generates tailored alternative interactions for the user based on selectively extracted interaction and resource data procured from competing entity systems. The alternative interactions are transmitted to the user in real-time, wherein at least some of the alternative interactions are not associated with the first entity. The user accepts or denies the one or more alternative interactions to trigger an interaction completion process on an entity system. Additionally, the invention may interrupt an in progress interaction to provide a user with alternative interactions before the in progress interaction can be completed.

### BACKGROUND

Users are beginning to rely on electronic solutions as an alternative to traditional brick-and-mortar resource procurement. As a result, the increased reliance on electronic resource exchange has expanded the focus of large entities to offer online interactions as a method for providing a broader assortment of resources and competitive resource interactions to users. Typically, this occurs outside of a physical establishment which in turn eliminates in-person opportunities for competitive resource offers and/or alternatives.

Entities are constantly exploring ways to communicate and conduct interactions with users utilizing mobile technologies. Many applications focus on promotion messaging that encourages user interaction at location associated with the entity. Many mobile applications for users are offered by third party service providers. While the service may vary, they are typically offer-based and utilize location services with the aid of zip codes and global positioning systems (GPS). These applications target interests such as establishment locators, weekly circulars, digital offers, generic alternatives, and the like.

Current technology provides resource search options to users along with the ability to find resources, locate where they may be procured, and a resource exchange amount. However, these applications offer entities little benefit unless they provide the most beneficial resource exchange or interaction to the user. Therefore, there is a need for a system to provide competitive online interaction results to a user located at an entity location such that the user may conduct an interaction with the entity comparable to competing interactions for a same or similar resource.

### BRIEF SUMMARY

Embodiments of the invention are directed to systems, methods, and computer program products for processing readable indicia for targeted data extraction and interaction manipulation. In an exemplary embodiment, the system may comprise an apparatus for processing readable indicia for targeted data extraction and interaction manipulation. The apparatus may have several components such as a memory, a processor, and a module stored in the memory, executable by the processor, and configured to execute one or more steps.

In one embodiment, the module may be configured to receive an alternative interaction request from a user, wherein the alternative interaction request indicates interest of the user in completing a resource exchange process for one or more resources provided by a first entity at a first entity location; establish, over a network, one or more operative communication channels with one or more other entity systems; extract targeted interactions from the one or more other entity systems based on the alternative interaction request from the user, wherein the targeted interactions are used to populate a database stored in the memory; generate one or more alternative interactions based at least in part on the alternative interaction request and the targeted interactions, wherein generating the one or more alternative interactions comprises identifying, in the database stored in the memory, one or more alternative interactions associated with at least one resource indicated in the alternative interaction request; transmit to the user the one or more alternative interactions in response to the alternative interaction request, wherein at least one of the one or more alternative interactions is related to a second entity associated with a second entity location; generate an interactive notification for the user to select at least one alternative interaction, wherein selecting the at least one alternative interaction is equated to accepting one or more terms and conditions associated with the at least one alternative interaction; and receive an option selection of the user.

In some embodiments, the module may be further configured to: establish an operative communication channel with an online entity system associated with an online entity, wherein interactions and communications between the user and the online entity are routed through the operative communication channel; detect an in progress interaction between the user and the online entity at an online entity location associated with the online entity; interrupt the in progress interaction before completion of the in progress interaction; generate a composite online entity location by manipulating a presentation of the online entity location to the user by incorporating the one or more alternative interactions, wherein the composite online entity location comprises the online entity location and the one or more alternative interactions; generate a notification within the composite online entity location presenting the one or more alternative interactions to the user for selecting an option; and in response to receiving the option selection of the user, end the in progress interaction and navigate the user to a new entity location associated with the option selection of the user.

In some embodiments, the module is further configured to: transmit the alternative interaction request to the first entity, wherein the alternative interaction request is sent in response to the user providing readable indicia associated with the one or more resources or manually inputting information associated with the one or more resources; and transmit competitor interaction information to the first entity, wherein the competitor interaction information includes a competitor offer for the one or more resources, and wherein the competitor interaction information is associated with at least one other entity associated with at least one other entity location.

In some embodiments, transmitting to the user one or more alternative interactions comprises the module being further configured to: receive a first entity alternative interaction, wherein the first entity alternative interaction offer is determined based at least partially on the competitor interaction information, and wherein determining the first entity alternative interaction comprises determining a resource exchange amount associated with the first entity less than a resource exchange amount indicated in the competitor interaction information or determining an offer not indicated in the competitor interaction information; and transmit the first entity alternative interaction to the user, wherein the first entity alternative interaction provides details for at least one of the resource exchange amount associated with the first entity and the offer.

In some embodiments, the module is further configured to: individually display, on a mobile device associated with the user, the at least one alternative interaction such that the alternative interaction is accompanied by the option to select the alternative interaction.

In some embodiments, not selecting the at least one alternative interaction is associated with denying one or more terms and conditions associated with the alternative interaction.

In some embodiments, the option selection of the user indicates the user denied the one or more alternative interactions, and wherein the module is further configured to: provide at least one entity with information related to the denial of the one or more alternative interactions, wherein the at least one entity includes the first entity; and receive a new first entity alternative interaction, wherein the first entity determines the new first entity alternative interaction based at least partially on the information related to the denial of the one or more alternative interactions such that the new first entity alternative interaction is subsequently sent to the user.

In some embodiments, sending the user one or more alternative interactions further comprises retrieving the one or more alternative interactions from the database stored in the memory.

In some embodiments, the user specifies one or more user preferences for receiving alternative interactions, and wherein the user preferences are related to pricing, location, or resource quality.

In some embodiments, the module is further configured to initiate an interaction completion process in response to receiving the option selection of the user.

In some embodiments, the module is further configured to: generate an interaction code based at least partially on the option selection of the user; and transmit the interaction code to the user, wherein the interaction code comprises information associated with the at least one resource and the at least one alternative interaction, and wherein the interaction code is displayed on a mobile device associated with the user.

In some embodiments, the alternative interaction request is received in response to the user providing readable indicia associated with the one or more resources, wherein providing the readable indicia comprises scanning, using a mobile device, a form of visual indicia associated with the one or more resources or manually inputting information associated with the one or more resources.

In some embodiments, the first entity location showroom is associated with one or more brick and mortar entity locations such that the user can physically interact with the one or more resources.

In an exemplary embodiment, a computer program product for processing readable indicia for targeted data extraction and interaction manipulation may be provided. The computer program product may comprise several components such as a non-transitory computer-readable medium comprising a set of codes for causing a computer to execute one or more steps. In one embodiment, the set of codes may cause a computer to receive an alternative interaction request from a user, wherein the alternative interaction request indicates interest of the user in completing a resource exchange process for one or more resources provided by a first entity at a first entity location; establish, over a network, one or more operative communication channels with one or more other entity systems; extract targeted interactions from the one or more other entity systems based on the alternative interaction request from the user, wherein the targeted interactions are used to populate a database stored in the memory; generate one or more alternative interactions based at least in part on the alternative interaction request and the targeted interactions, wherein generating the one or more alternative interactions comprises identifying, in the database stored in the memory, one or more alternative interactions associated with at least one resource indicated in the alternative interaction request; transmit to the user the one or more alternative interactions in response to the alternative interaction request, wherein at least one of the one or more alternative interactions is related to a second entity associated with a second entity location; generate an interactive notification for the user to select at least one alternative interaction, wherein selecting the at least one alternative interaction is equated to accepting one or more terms and conditions associated with the at least one alternative interaction; and receive an option selection of the user.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### BRIEF DESCRIPTION OF THE DRAWINGS

Having thus described embodiments of the invention in general terms, reference will now be made to the accompanying drawings, where:

FIG. 1 provides a diagram illustrating a data extraction and interaction manipulation system environment 100, in accordance with embodiments of the present invention;

FIG. 2 provides a flow diagram illustrating a process for processing readable indicia for targeted data extraction and interaction manipulation 200, in accordance with embodiments of the present invention;

FIG. 3 provides a flow diagram illustrating a process for providing entity alternative interactions at an entity location 300, according to an embodiment of the present invention;

FIG. 4 provides a flow diagram illustrating a process for initiating an interaction based on an alternative interaction for a resource at an entity location 400, according to an embodiment of the present invention;

FIG. 5 provides a block diagram illustrating high level use cases for targeted data extraction and interaction manipulation 500, according to an embodiment of the present invention;

FIG. 6 provides a block diagram illustrating a process for combating show rooming 600, in accordance with embodiments of the present invention;

FIG. 7 provides a block diagram illustrating a process for eliminating rain checks 700, in accordance with embodiments of the present invention;

FIG. 8 provides a block diagram illustrating a process for in-hand warehousing, in accordance with embodiments of the present invention 800; and

FIG. 9 provides a block diagram illustrating a method for processing and completing an interaction 900.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. As used herein a “user” refers to a previous user or a non-user of one or more entities. In some embodiments, a user may be a consumer or a non-consumer of one or more merchants or entities associated with one or more merchants. The terms “user” and “consumer” as used herein may be used interchangeably throughout the specification. Furthermore, as used herein, the term “resource” shall mean one or more products, goods, services, events, etc. that may be offered by a merchant. In addition, the term “offer” is used herein to denote any form of offer, promotion, rebate, coupon, incentive, reward, deal, loyalty program and/or the like offered for the purchase, lease, and/or the like of a product. A “coupon” as used herein may refer to a deal and/or the like of a product. An “interaction” or “transaction” as used herein may refer to a purchase, lease, barter, exchange, and/or any other form of transfer of a resource from an entity to a user. In some embodiments, an “interaction” may further refer to a presentation of an offer from an entity to a user. In some embodiments, an “alternative interaction” may refer to an interaction that has been altered by the entity or supplemented with an additional offer. An “alternative interaction” may refer to any interaction offered by the entity or another entity to a user that is different than an initially offered integration. Completion of an interaction or transaction may comprise an exchange of resources between an entity and a user for an agreed upon amount (i.e., payment). An “entity” as used herein may refer to a merchant, business, manufacturer, retailer, service provider, event provider, warehouse, supplier, and/or the like. Furthermore, as used herein, the terms “merchant” and “retailer” may be used interchangeably with the term “entity” throughout the specification. In some embodiments, an entity may be a user of the targeted data extraction and interaction manipulation system described herein. In some embodiments, entity may be a financial entity or financial institution such as a bank, credit card company, or the like. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein, “based on” means “based at least in part on” or “based at least partially on.”

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the invention are directed to systems, methods and computer program products for processing readable indicia for targeted data extraction and interaction manipulation. The invention enables an entity to provide users with alternative interactions, such as promotional information, so that an entity can compete with other entities (e.g., competitor entities, online entities, and the like) and present an alternative interaction to the user at a location of the entity based on the competition, where the user can accept the alternative interaction in real-time.

As an example, a user may enter an entity location and locate a resource of interest (i.e., a product, good, service, or the like). The user may then present a form of readable indicia to a mobile application, where the readable indicia is related to a resource of interest and indicates several items of information about the resource. The mobile application may then transmit the information to an application server such that the system can provide the user with a plurality of alternative interactions related to the resource. The system may establish operable communication channels with systems of the entity and other entities (i.e., other entity locations, competing entities, online entities, and the like) in order to extract alternative interactions associated with the user and/or resource of interest. In this way, the alternative interactions may be associated with other entity locations, competing entities, and/or online entities allowing the user to decide which interaction reflects the best value for the resource of interest. The processes performed by the invention and described herein cannot be performed by a human being mentally or with pen and paper within a typical time frame of a user visiting an entity location. The shear amount of information needing to be extracted through multiple various electronic communication channels, parsed, and then incorporated into a complex resource exchange model is insurmountable for a human being to accomplish, let alone within the time frame of a user requesting an alternative interaction and completing an interaction process (i.e., making a purchase). This dependence on computer technology is further heightened with the increasing usage of mobile technology to complete interactions within seconds at any location and time. The invention as described herein solves this technical problem by generating and presenting alternative interactions to the user in real time.

Due to the taxing nature of the targeted data extraction and pricing model creating, the invention cannot be operated using solely generic computer hardware. Instead, particular computer hardware such as dedicated servers for constant monitoring of alternative interactions (e.g., available through the Internet and extracted from competitor entity systems) and integration and comparison of extracted results with entity models as well as databases for storing, maintaining, and updating extracted alternative interactions. Furthermore, the invention includes a decision engine comprised of the various dedicated servers, databases, and models for generating alternative interactions in real-time. In this way, the invention may generate and present an alternative interaction to the user at the entity location before the user leaves the location or completes a different interaction with another entity. These particular, dedicated computer hardware components requires complex computer code to facilitate the comparison of all extracted and collected alternative interactions from other entities to generate a best alternative interaction and manage the interface connecting the user and entity systems and integrate the systems and process of the invention into in-store and online point-of-sale software and hardware devices. Without the invention creating the ability to present offers to users in real-time and intercept user actions and communications for searching alternative interactions with other entities, an entity would not know that a user has found another, better alternative interaction and would not be able to actively generate and transmit user-specific, target alternative interactions to the user in real-time to prevent a user leaving the entity location and losing a potential interaction (i.e., a sale). In some embodiments, the invention may be software installed on one or more systems. In another embodiment, the invention may be hardware installed on one or more systems (i.e., entity systems, user systems, point-of-sale devices, mobile devices, or the like).

The system may also communicate the user's interest in the resource to the entity where the user is located (e.g., within a merchant location, business, store, or the like). In this way, the entity is equally capable of providing a plurality of alternative interactions for presentation to the user along with the other entities. The system may further provide the entity with information about the other competitor entities' current interaction offerings (i.e., pricing and promotional offers) allowing the entity to develop an alternative interaction or offer to present to the user that is highly competitive in respect to other entities. This may encourage the user to complete an interaction in-store with the entity versus leaving and purchasing the resource of interest elsewhere. Upon a user acceptance of an alternative interaction the user may be provided a barcode, or other readable indicia, which can be presented to the entity using the user mobile device, where the barcode is shown on a display associated with the user mobile device. The entity or merchant may then scan the barcode and process the user's transaction. The barcode may encompass several items of information including, but not limited to, information related to the resource (e.g., product name, specifications, pricing, location and the like), information related to the accepted offer (e.g., agreed upon price or terms), and payment information associated with the user (e.g., account information, routing information, a payment vehicle, or the like).

In further embodiments of the invention, the system may interrupt an online interaction between a user and an online entity. The system may detect an in progress interaction or transaction between a user and an online entity through an established operable communication channel with the online entity or through the interaction which may be initiated, routed, or conducted through the one or more systems and devices of the invention as a part of the one or more processes described herein. In some embodiments, the system may interrupt the online interaction before completion of the interaction (i.e., finalizing payment) and present one or more alternative interactions to the user. In this way, the system may manipulate an online entity location (e.g., a webpage, an online checkout process, a shopping interface, an online cart, or the like) and incorporate the one or more alternative offers into the online entity location. In some embodiments, the invention may route the online entity's webpage or the like through the systems of the invention to present a composite webpage or the like to the user to incorporate the one or more alternative interactions into the normally closed entity webpage. The system may incorporate generated alternative interactions into the entity webpage while retaining the overall appearance of the entity webpage. In some embodiments, the system may generate a message, notification, or text box over the top of a price or checkout option of the entity webpage that must be accepted or denied in order to progress with the initial interaction with the online entity. In other embodiments, the system may present the alternative interactions beside the initial interaction of the online entity in order to allow the user to view and compare the competing alternative interactions beside one another. In some embodiments, by a user accepting an alternative interaction presented by the system within the online entity's webpage, the system may close the user's open session with the online entity and navigate the user to a new location associated with the entity of the accepted alternative interaction.

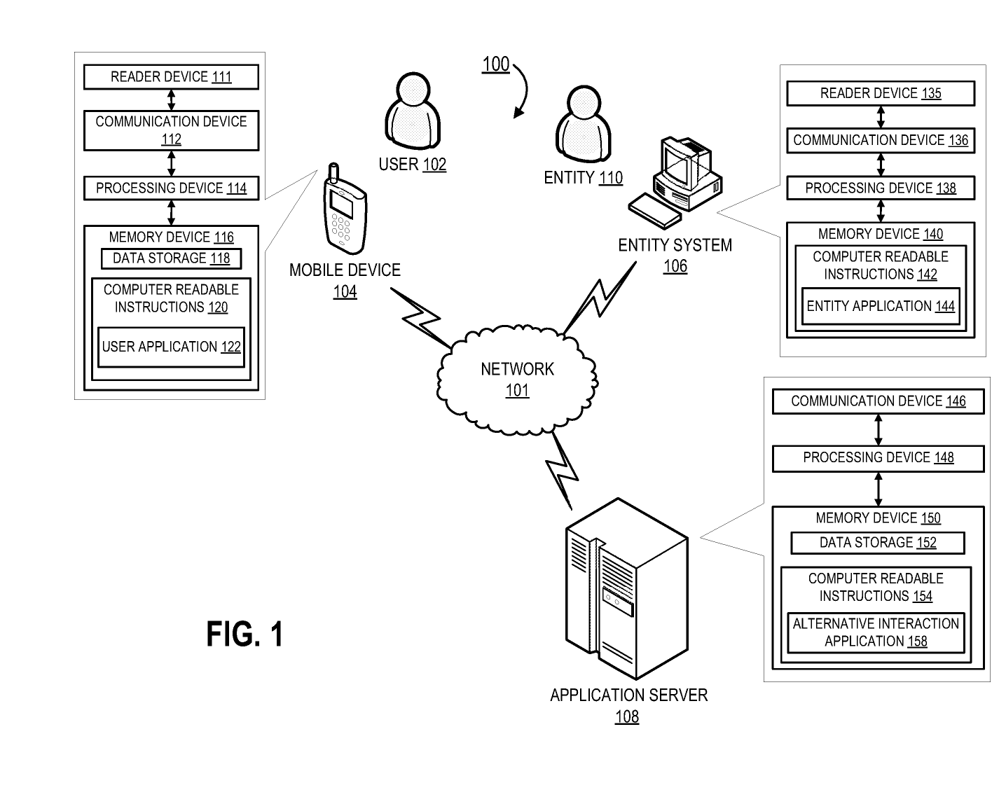

FIG. 1 provides a data extraction and interaction manipulation system environment 100, in accordance with one embodiment of the present invention. As illustrated in FIG. 1, the application server 108 is operatively coupled, via a network 101 to the mobile device 104, and to an entity system 106. It should be noted that entity systems could include both an entity account interface as well as an entity end system, such as a cash register, point-of-sale terminal, or the like. It should also be noted, in some embodiments the mobile device 104 may be interchanged with other end user systems, such as a computer, tablet, or the like. In this way, the application server 108 can send information to and receive information from the mobile device 104 and the entity system 106 to match and provide user-specific offers to a user 102. FIG. 1 illustrates only one example of an embodiment of a data extraction and interaction manipulation system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network. The system may establish one or more operative communication channels over the network 101 to one or more entity systems to extract alternative interaction data from the entity system. The system may also intercept interactions in progress which may be routed through the systems of the invention to incorporate one or more alternative interactions into an interaction completion process associated with the user.

In some embodiments, the user 102 is an individual processing an interaction or considering an interaction with the entity. The interaction or transaction may be made at an entity system 106 of an entity, online or offline, over the phone, at the entity's place of business and/or other transaction means. The purchase may be initiated by the user 102 using a mobile device 104, such as a mobile wallet (i.e. smart phone, PDA, etc.) or other types of payment systems that communicate with entity systems 106 and/or application servers 108 to allow the entity 110 to process an interaction or transaction. In other embodiments, the user 102 may make transactions using a card with stored magnetic information, digital information, or other like payment device that stores information that may be transferred to an entity system 106 and/or an application server 108 to allow a user 102 to make a transaction, such as a credit card, debit card, gift card, and/or the like. In some embodiments, the entity 110 may be a merchant or a person, employee, agent, independent contractor, an employee acting on behalf of the entity to enter and process a transaction. In other embodiments, the entity 110 may be an automated system that automatically processes transactions (e.g., an online checkout system or an automated checkout line).

As illustrated in FIG. 1, the application server 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to the entity system 106 and the mobile device 104. As such, the communication device 146 generally comprises a modem, server, or other device for communicating with other devices on the network 101.

As further illustrated in FIG. 1, the application server 108 comprises computer-readable instructions 154 stored in the memory device 150, which in one embodiment includes the computer-readable instructions 154 of an alternative interaction application 158. In some embodiments, the memory device 150 includes data storage 152 for storing data related to the alternative interaction application 158 including but not limited to data created and/or used by the alternative interaction application 158 or the information of users 102. The data storage 152 may also store all alternative interactions or offers provided by entity systems 106 such that the alternative interaction application 158 may match the alternative interactions stored with a user's 102 interest.

In the embodiment illustrated in FIG. 1 and described throughout much of this specification, the alternative interaction application 158 allows the user 102 to interact with the system. First, the alternative interaction application 158 allows a user 102 to search for competitive, alternative interactions for a resource of interest, via the mobile device 104. Next, the alternative interaction application 158 allows the entity 110 to manually input alternative interactions or offers related to resources the user 102 may wish to procure, via the entity system 106. Both searching for and manually inputting alternative interactions (e.g., competitive pricing and resource offers) may be performed by a using an interface, such as a mobile device 104 or entity system 106, provided from the alternative interaction application 158 via a network 101.

In some embodiments, the alternative interaction application 158 allows the user 102 to communicate, via the mobile device 104, to indicate resources that the user 102 may wish to procure. This communication may be in the form of text communications, voice communications, or the like. Typically, alternative interactions or offers for resources of interest that the user 102 may wish to purchase may be provided by the entity 110 through an interface on the mobile device 104, such as that illustrated in FIG. 1. The alternative interaction application 158 may receive the alternative interactions from the entity system 106 once the entity 110 has inputted the resources or alternative interactions onto the interface. It should be noted that the entity 110 may refer to a merchant associated with a merchant store where a user 102 is a consumer currently shopping for a resource or product of interest, while other merchants where the user 102 is not currently located may also be represented within the interface through the extraction and presentation to the user of alternative interactions associated with the other merchants.

The local (i.e., in-store) alternative interactions provided by the entity at which the user is located may be more beneficial to a user 102 than other alternative interactions that may be provided by other competing entities or online entities and merchants. This is largely due to the ability to provide the entity 110 with resource-specific information related to alternative interactions provided by other entities in competition with the entity 110. In this way, the alternative interactions may entice the user 102 to accept a local alternative offer (i.e., make an in-store purchase) based upon the real-time alternative interaction or offer provided by the entity 110 versus leaving and completing an interaction at an entity location different than the one at which he/she is currently shopping. These alternative interaction offers (i.e., discounts, coupons, additional offers, and the like) for resources may be passed on to the user 102 based at least partially on the user indicating an interest in the resource while at the location of the entity 110 (i.e., a place of business, store, show room, website, and the like). Thereafter, the user 102 may frequent the entity's 110 in-store location more often based upon the ability to receive additional alternative interaction offers while shopping in-store. The alternative interactions provided through the system may comprise special offers that are exclusively provided to the user 102 from the entity 110. In this way, the user 102 may receive more beneficial offers through completing interactions with the entity 110 than any other entity location.

The entity 110 or merchant, through the entity system 106, may provide the alternative interaction application 158 data with respect to the alternative interactions available. The alternative interaction application 158 may then store the data related to the entity 110 offer such as, but not limited to the resource, the alternative interaction, the location for the alternative interaction, business rules associated with alternative interactions etc. In this way, the alternative interaction application 158 may have access to all alternative interactions or offers available from all entities 110, in a database, to utilize when matching the user 102 with one or more alternative interactions. In some embodiments, the system may establish an operable communication channel to one or more other entity system (e.g., competitors, other entity locations, third parties, and the like) and extract alternative interactions and data related to similar interactions or resource. In some embodiments, the system may target alternative interactions and data stored on other competitor systems related to a user, a resource, an offered alternative interaction, or the like. In this way, the system only extracts the information pertinent to the interaction at-hand with the user and does not need to pull the entirety of the information every time the system generates and presents an alternative offer to the user at the entity location.

In some embodiments, the system employs web scraping techniques to identify all published alternative interactions and offers associated with a resource of interest. In some embodiments, the system may convert an extracted alternative interaction from a source location format (e.g., HTML, CSS, client-side scripting, JavaScript, ActionScript, server-side scripting, PHP, Java, Python, Ruby, or the like) to a new format (e.g., text file, delimited text file, csv file, or the like) compatible with a storage format, such as a table, stored on a database of the system. The extracted alternative interactions may be placed into a table that may be referenced by the system for generating alternative interactions using pricing models and the decision engine. The system generates, maintains, and indexes a database of every identified entity or retailer, wherein the table is populated with the extracted information. In some embodiments, the entity name is placed into a column of the table, wherein the same table persists as more entity names are added over time. The table is populated with alternative interactions, offers, pricing information, and the like associated with each entity. In this way, a holistic view of competing entities and alternative interactions may be generated and maintained by the system for reference. In some embodiments, the system only reads those entries of the table that have been populated. In this way, the system may not waste computing resources attempting to reference entity entries that are not populated with alternative interactions pertinent to the user and the interaction at hand.

The alternative interaction application 158 may also receive data from the entity system 106. The entity system 106, as explained in further detail below, allows the alternative interaction application 158 to determine the location of the entity 110 such that it can be matched with a recent resource interest of the user 102. Because the entity system 106 may send authentication for a user 102 interaction to the application server 108 or other application servers, the alternative interaction application 158 may receive data regarding the interaction from the application server 108 or the other application servers. In this way, the alternative interaction application 158 may determine and store in the data storage 152 information relating to the location of the potential interaction (i.e., an interaction determined from user interest in a resource) and the resources of the potential interaction. The location of the potential interaction may be determined due to the entity system location or other means such as global positioning systems (GPS), mobile device 104 locators, or the like. In some embodiments, the location data is determined by an entity system 106. In this way the location data may be analyzed to verify the user 102 is within the specific area. In this way, the location data provided by the entity system 106 to the alternative interaction application 158 may aid in providing the user 102 alternative interactions or offers for resources from entities within an entity area and/or online. In some embodiments, the entity area may be the same entity area the user 102 is currently shopping. In some embodiments the entity area may be a different entity area than the one the user 102 is currently shopping. The location data may also aid the alternative interaction application 158 in notifying the entity 110 that an interested user 102 has left the entity area.

In some embodiments, the location of the user 102 may not be required for the alternative interaction application 158 to provide alternative interactions from the entity 110 to the user 102. In this example, the entity 110 offer may be provided by the user 102 scanning readable indicia, such as a barcode, related to the resource in which they are interested. The readable indicia may also be encoded such that it has location information associated with the current location of the resource. In this way, the alternative interaction application 158 is notified of the resource location in response to the readable indicia being scanned. To this extent, the alternative interaction application 158 may provide the user 102 offers from the entity 110 in relation to other interaction options (i.e., pricing, offers, alternative resources, and the like) available for the resource at alternative locations. In other embodiments, the user 102 may specify the area from which they want to receive alternative interaction options. In one embodiment, alternative interactions and/or options may be provided from online entities. In another embodiment, alternative interactions and/or options may be provided by other entities within an area similar to entity 110.

The data stored within the alternative interaction application 158 provides computer readable instructions 154 to the processing device 148 to allow for the matching of an alternative interaction received from an entity system 106 with a user 102 based on the user's 102 location data and search request data. The alternative interaction application 158 stores the matched interactions and communicates the alternative interactions or offers to a user 102 via a network 101 to the user's 102 mobile device 104.

Matching alternative interactions provided by entities 110 with users 102 may require an analysis of the user's 102 search requirements. The search requirement may indicate a resource of interest and one or more characteristics associated with the resources of interest, such as particular resource specifications. The alternative interaction application 158 may provide an alternative interaction or offer to a user 102 based on a combination of factors. Furthermore, if more than one pricing option is being presented to the user 102, the entity 110 may present an additional offer supplementing the current local price, thus enticing the user 102 to complete the interaction where the real-time alternative interaction is being provided to the user 102. The alternative interaction application 158 uses these factors to determine which alternative interactions or offers from entities 110, the alternative interactions stored in a database in data storage 152, are appropriate for the user 102. In some embodiments, the alternative interaction may be for resources that it may be determined that the user 102 may be interested in. In some embodiments, the alternative interaction may be for an entity where the user 102 is currently located. In yet other embodiments, the alternative interaction may be for an entity area that the user 102 may not frequent and/or may have to travel to.

The users 102 location may be determined by the alternative interaction application 158 through location data. Location data may be established by data sent from the entity system 106, GPS data associated with the user 102 or the user's 102 mobile device 104, interaction or transaction history data, etc. stored in the application server 108 and the like. For example, an entity system 106 may be used by a user 102 at an entity 110 to complete an interaction or transaction. Along with the authentication data needed to authenticate exchange of resources between a user and entity (i.e., payment for the purchase of a resource), the entity system 106 may also send information as to the location of the entity 110 to the alternative interaction application 158. Therefore, the alternative interaction application 158 may receive address information or at least general geographic indication information for the entity 110 where the user 102 just completed an interaction. Location data may also be received by the alternative interaction application 158 from a mobile device 104 of a user 102, the entity 110, GPS data, or the like. In this way, the location of the user 102 may be known, even if the user 102 is not making a purchase. Therefore an alternative interaction may be provided to the user 102 at any time, independent of the user 102 making a transaction.

As illustrated in FIG. 1, the entity system 106 generally comprises a reading device 135, a communication device 136, a processing device 138, and a memory device 140. The reading device 135 is operatively coupled to the processing device 138, communication device 136, and the memory device 140. The entity system 106 may include a reader device 135 to receive payment account information from the user 102 through the mobile device 104 and/or other payment devices. Such a reader device 135 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 135 receives information that may be used to identify the user's 102 payment account and/or transaction data at the entity system 106 and communicates the information via the communication device 136 over a network 101, to other systems such as, but not limited to the application server 108, other systems, and/or the commercial partner systems. As such, the communication device 136 generally comprises a modem, server, or other device for communicating with other devices on the network 101.

As further illustrated in FIG. 1, the entity system 106 comprises computer-readable instructions 142 stored in the memory device 140, which in one embodiment includes the computer-readable instructions 142 of an entity application 144. An entity system 106 may refer to any device used to perform an interaction or transaction, either from the user's 102 perspective, the entity's 110 perspective or both. In some embodiments, the entity system 106 may refer only to a user's device, in other embodiments it refers only to an entity device, and in yet other embodiments, it refers to both a user device and an entity device interacting to perform a transaction. For example, in one embodiment, the entity system 106 refers to the user's 102 mobile device 104 configured to communicate with an entity's point of sale terminal, whereas in other embodiments, the entity system 106 refers to the entity's point of sale terminal configured to communicate with a user's 102 mobile device 104, and in yet other embodiments, the entity system 106 refers to both the user's mobile device and the entity's point of sale terminal configured to communicate with each other to carry out and complete a transaction.

In some embodiments, an entity system 106 is or includes an interactive computer terminal that is configured to initiate, perform, complete, and/or facilitate one or more interactions. An entity system 106 could be or include any device that a user may use to perform an interaction with an entity, such as, but not limited to, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), an entity terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In the embodiment illustrated in FIG. 1, the entity application 144 allows the entity system 106 to be linked to the application server 108 to communicate, via a network 101, the information related to the interaction being made, such as the interaction type, cost of interaction, resource type, entity location, user 102 location, etc. In this way, the entity application 144 may provide the alternative interaction application 158 with location data and recent interaction data, such that the alternative interaction application 158 may determine appropriate geographic information to associate with the offer match for the user 102. In one example, the user 102 enters into an interaction at an entity system 106, which processes the interaction and the entity application 144 allows communication of the interaction information to the application server 108.

The entity application 144 may also receive information from the application server 108. The entity application 144, in some embodiments, may receive an offer or offers from the alternative interaction application 158, such that the entity application 144 may display the offer or offers to the user 102 on a display on the entity system 106. In this way, the user 102 may receive an offer to purchase the resource that the user 102 is already in the process of purchasing with an online entity or merchant (e.g., an online retailer, store, or the like). The offer may be displayed on the entity system 106 such that the user 102 may accept the offer prior to the completion of the transaction. In some embodiments, an interaction may be routed or completed through the one or more systems of the invention, wherein the invention may intercept and interrupt an interaction before completion in order to present alternative interactions during an interaction completion process.

FIG. 1 also illustrates a mobile device 104. The mobile device 104 generally comprises a reader device 111, communication device 112, a processing device 114, and a memory device 116. The reading device 111 is operatively coupled to the processing device 114, communication device 112, and the memory device 116. The mobile device 104 may include a reader device 111 to receive resource information from the entity 110. Such a reader device 111 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 111 receives information, such as readable indicia, that may be used to identify the entity's 110 offer data at the entity system 106 and communicates the information via the communication device 112 over a network 101, to other systems such as, but not limited to the application server 108, the entity system 106, and/or other systems. The processing device 114 is likewise operatively coupled to the communication device 112 and the memory device 116. The processing device 114 uses the communication device 112 to communicate with the network 101 and other devices on the network 101, such as, but not limited to the entity system 106 and the application server 108. As such, the communication device 112 generally comprises a modem, server, or other device for communicating with other devices on the network 101.

As further illustrated in FIG. 1, the mobile device 104 comprises computer-readable instructions 120 stored in the memory device 116, which in one embodiment includes the computer-readable instructions 120 of a user application 122. In this way, a user 102 may be able to receive, deny, and accept alternative interactions or offers, make payments for transactions, and/or the like using the user application 122. Furthermore, the mobile device 104 comprises a data storage 118 application within the memory device 116 to store data associated with the mobile device 104. A “mobile device” 104 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single mobile device 104 is depicted in FIG. 1, the system environment 100 may contain numerous mobile devices 104.

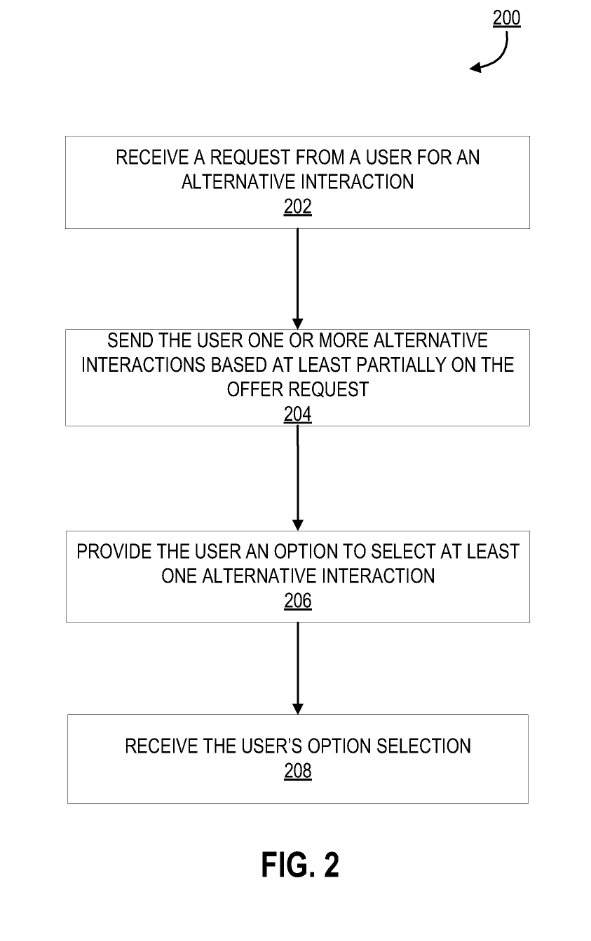

Referring now to FIG. 2, a flow diagram illustrating a process for processing readable indicia for targeted data extraction and interaction manipulation 200, in accordance with embodiments of the present invention, is provided. At event 202, the system may receive a request from the user 102 for an alternative interaction. The alternative interaction request may indicate the user's 102 interest in one or more resources of the entity 110 (e.g., showcased in a store, available on a website). Receiving an alternative interaction request may comprise sending information via a user application 122 to the application server 108 to indicate the users 102 interest in a resource. An alternative interaction request may be received in response to the user 102 scanning readable indicia, such as a code, associated with the resource. The readable indicia may be scanned using the reader device 111 associated with the mobile device 104. In one embodiment, the readable indicia may be a one-dimensional code such as a barcode. In another embodiment, the readable indicia may be a two-dimensional code such as a Quick Response (QR) code. An alternative interaction request may be received in response to the user 102 entering resource information into the user application 122 such that the resource information is sent to the application server 108. Resource information may comprise the resource(s) name, manufacturer, make/model, characteristics (e.g. color, size, etc.), location, SKU number, cost, and the like. In one embodiment, resource information may be presented in the form of an alphanumeric code, such that the user 102 enters the alphanumeric code into the user application 122 and resource information is sent to the application server 108 indicating the users 102 interest in the related resource. In another embodiment, the readable indicia and/or resource information may be used for the alternative interaction application 158 to recognize a specific resource of interest and alert the entity 110.

The user 102 may specify the types of alternative interactions or offers they want to request. In one embodiment, the user 102 may specify that they want to receive the best or most beneficial alternative interactions available for a resource. The best alternative interaction may reflect the offer which indicates the lowest cost for a specific resource. The best alternative interaction may also reflect the offer which indicates the closest location for a specific resource. In another embodiment, the user 102 may specify that they want to receive money-saving offers. Money-saving offers may comprise offers that provide coupons, discounts, rebates and the like.

At event 204, the system may send the user 102 one or more alternative interactions based at least partially on an alternative interaction request received from the user 102. The one or more alternative interactions may be related to a plurality of entities which offer the resource of interest. In one embodiment, the entities may be other in-store merchants or retailers located within a specific area. In another embodiment, the entities may be online merchants or retailers. In yet another embodiment, the entities may be a combination of both in-store and/or online merchants and retailers. In one example, the user 102 may request the best alternative interactions available for a resource. As such, the application server 108 may analyze the resource information and retrieve a range of offers, related to the resource of interest, that are available. In return, the system may send the user 102 one or more alternative interactions which reflect the best value for the resource. In another example, the user 102 may request to receive money-saving offers available for a resource. As such, the application server 108 may analyze the resource information and retrieve a range of alternative interactions, related to the resource of interest, that are available for immediate use at the entity location. In return the system may send the user 102 one or more alternative interactions which indicate money-saving options, such as coupons, for the user 102 to immediately use. In such an embodiment, the coupon may be applied to the users 102 purchase while processing the transaction.

Sending the user 102 one or more alternative interactions may further comprise retrieving the one or more alternative interactions stored in the application server 108. Alternative interactions or offers may be generated by a plurality of means and stored in the application server 108 for later use in matching alternative interactions with user 102 resource interest. Alternative interactions may also be generated in real-time such that the offers are available for immediate use. Alternative interactions may be retrieved from online sources, entities, corporations, manufactures, and/or be user specific generated offers. Online offers may be generated or extracted based upon online coupon and/or resource searches. Entity offers may be generated or extracted based upon flyers/circulars, in-store offers, inventory, pricing, transaction history, and the like. Corporate offers may be generated or extracted based upon online retailer offers, inventory, online pricing options, delivery options, timing of interest, various resource related fees, and the like. Manufacturer offers may be generated or extracted based upon direct custom offers, unadvertised offers, and the like. User specific offers may be generated or extracted based upon purchase history, entity loyalty, and the like. In another embodiment, the system may use web scraping mechanisms to locate the best offers available. In some embodiments, the system may target alternative interactions, data, and offers for extraction from other, competitor entity systems based on the aforementioned conditions. By targeting specific, select alternative interaction information and data related to the resource of interest or the user, the system may successfully manipulate an interactions by presenting the user with alternative interactions that the user may find more appealing than an initial interaction that the user does not accept.

At event 206, the system may provide the user 102 an option to select at least one of the alternative interactions or offers sent to the user's mobile device 104. In some embodiments, the system may generate an interactive notification or message with the user interface allowing the user to select at least one alternative interaction. In one embodiment, each alternative interaction may be individually displayed on the user's mobile device 104 along with an option to accept or deny the offer. In another embodiment, one or more alternative interactions may be collectively displayed on the users' mobile device 104 along with an option to accept or deny the one or more offers. In such an embodiment, the user may be able to select multiple alternative interactions and choose an option which states “accept all” or “deny all”. In one embodiment, failing to explicitly accept or deny any alternative interaction may be equated to denying the alternative interaction. At event 208, the system may receive the user's 102 option selection such that the system is provided information indicating whether the user 102 has chosen to accept and/or deny one or more of the alternative interactions presented.

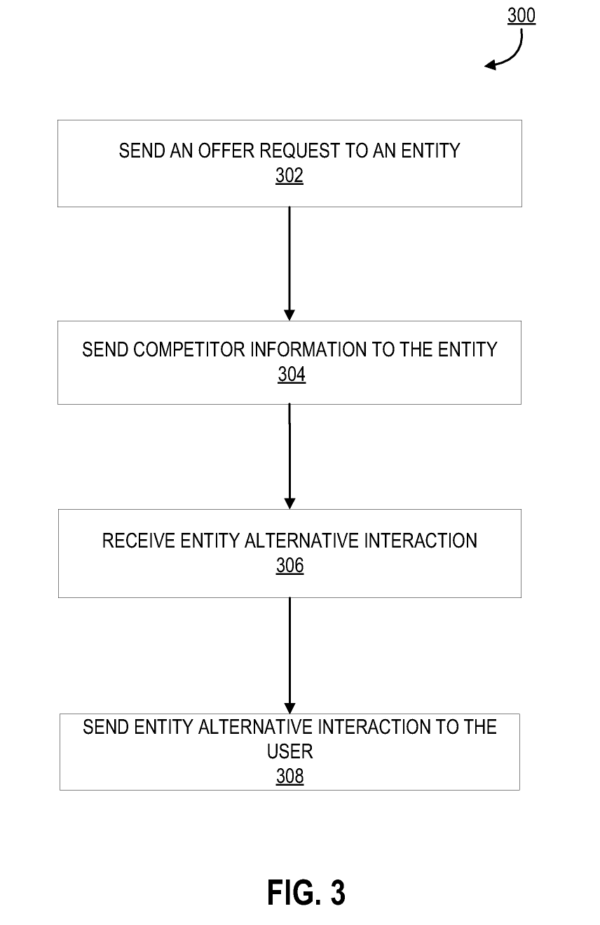

Referring now to FIG. 3, a flow diagram illustrating a process for providing entity alternative interactions at an entity location 300, according to an embodiment of the present invention, is provided. At event 302, the system may send the entity 110 an alternative interaction request from the user 102. The alternative interaction request may indicate the user's 102 interest in one or more resources provided by the entity for a potential interaction (e.g., for a resource that is showcased and for-sale in an entity store). Sending an alternative interaction request may comprise sending information via the application server 108 to the entity system 106 to indicate the users 102 interest in a resource. An alternative interaction request may be sent in response to the user 102 scanning readable indicia, such as a code, associated with the resource. An alternative interaction request may be sent in response to the user 102 entering resource information into the user application 122 such that the resource information is sent to the application server 108 and resource interest is conveyed to the entity 110. Resource information may comprise the resource(s) name, manufacturer, make/model, characteristics (e.g. color, size, etc.), location, SKU number, cost and the like. In one embodiment, resource information may be presented in the form of an alphanumeric code, such that the user 102 enters the alphanumeric code into the user application 122 and resource information is sent to the entity 110 indicating the users 102 interest in the related resource.

At event 304, the system may send the entity 110 competitor information associated with the resource of interest. The competitor information may include current prices, alternative interactions, and/or offers for the resource at different entity locations. The competitor information may be related to a plurality of entities which offer the resource of interest. In one embodiment, the entities may be other in-store retailers (i.e., brick and mortar locations) located within a specific area. In another embodiment, the entities may be online retailers. In yet another embodiment, the entities may be a combination of both in-store retailers and/or online retailers. In one embodiment, the system may only list information associated with competitive entities or retailers that have current prices for the resource of interest that are less than or equal to the current price listed by the merchant 110. In another embodiment, the system may list information associated with entities that have current prices for the resource of interest that are less than, greater than, and/or equal to the current price listed by the entity 110. In yet another embodiment, the system may only list information associated with competitive entities that are located within in a specific geographic.

The entity 110 may use the competitor information received to determine an alternative interaction to provide the user 102 in relation to the resource of interest. The entity 110 may create an alternative interaction to send to the user 102 based on at least one or more business rules or pricing models within an alternative interaction decision engine. In one embodiment, the one or more business rules may be based at least partially on the retail margin. For example, the entity 110 may take into consideration retail cost of the resource of interest and compare it with the user 102 price to create a retail margin. In such an embodiment, the entity 110 business rule may indicate that a resource can be offered to the user for any discounted price where the discount does not exceed the amount of the retail margin. In this way, the entity may compete with the best price provided by its competitors as long as the competitive offer price does not create a deficit in the retail margin. In one embodiment, the one or more business rules may be provided by the entity 110 and stored in the application server 108 such that upon receiving an alternative interaction request for a resource of interest the application server 108 can determine an appropriate alternative interaction to send the user 102 based on at least one of the business rules without first consulting the entity 110. In another embodiment, the one or more business rules may indicate whether a resource of interest should be shipped to the user 102 or available for pick-up. In some embodiments, the entity alternative interaction includes a discounted price with relation to the competitor pricing and/or a purchase incentive for purchasing the resource from the entity such as free in-home delivery and setup, a percentage off a second resource purchased, a monthly subscription service and/or the like.

After an entity 110 alternative interaction (i.e., an alternative interaction offered by the entity) has been created, at event 306, the entity alternative interaction may be received by the application server 108. In one embodiment, receiving the entity alternative interaction may comprise receiving the one or more business rules from the entity 110 where the one or more business rules may be used to create an entity alternative interaction on behalf of the entity 110. In one embodiment the entity alternative interaction is sent by the entity system 106 and received by the application server 108.

At event 308, upon receiving an entity alternative interaction, the entity alternative interaction may be sent to the user 102 such that the user may either accept or deny the alternative interaction being presented. In one embodiment, the entity alternative interaction may be sent to the user by the application server 108 and displayed via the user application 122. In another embodiment, the entity alternative interaction may be sent to the user 102 by the application server 108 via other forms of mobile communication such as text, mobile SMS, email, and the like.

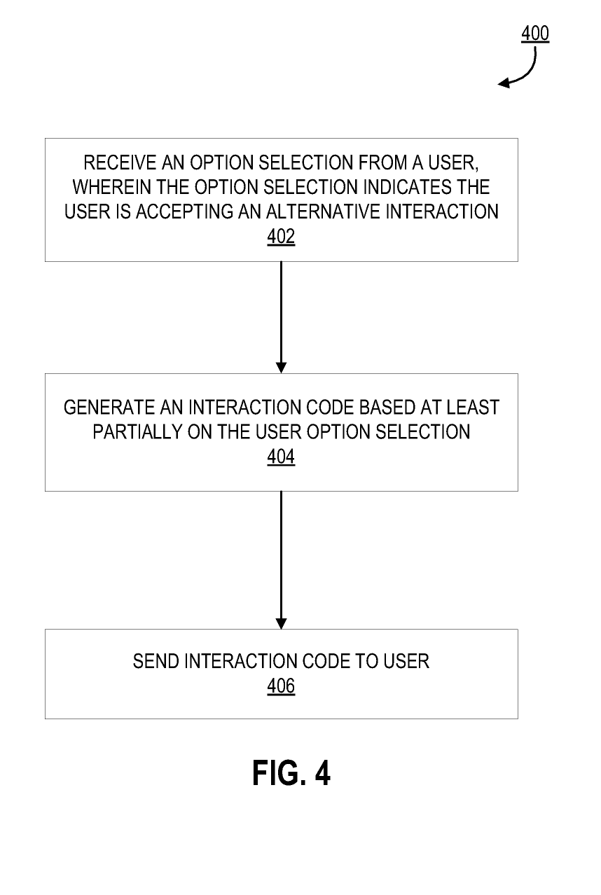

Referring now to FIG. 4, a flow diagram illustrating a process for initiating an interaction based on an alternative interaction for a resource at an entity location 400, according to an embodiment of the present invention, is provided. At event 402, the system may receive an option selection from a user 102. In one embodiment, the option selection may indicate that the user 102 has chosen to not accept one or more alternative interactions. In such an embodiment, the system may send the information to the entity 110 such the entity 110 can provide the user 102 another alternative interaction. The entity 110 may choose to offer the user 102 the previous alternative interaction along with a supplemental offer. For example, the entity 110 may initially offer the user 102 $100 off the resource of interest, where the resource of interest may be a television. In the instance that the user 102 chooses to not accept this alternative interaction, a denial of the alternative interaction may be transmitted to the application server 108 and conveyed to the entity 110 such that the interaction is prevented from being completed and the entity 110 may choose to furthermore offer the user 102 a free DVD player in addition to the $100. In an alternative embodiment, the entity 110 may choose to offer the user 102 an entirely new alternative interaction. In one embodiment, the entity 110 may be informed about the option selection from the user 102 such that the option selection indicates the user 102 has chosen to accept an alternative interaction provided by another entity location and deny the alternative interaction provided by the entity 110. In such an embodiment, the entity 110 may resend the user 102 another alternative interaction prior to the user 102 completing an interaction with another entity (i.e., competitive retail location). The offer may be instantaneously sent to the user 102 such that the user 102 receives the new alternative interaction from the entity 110 prior to leaving the entity's store. In one embodiment, the option selection may indicate that the user 102 has chosen accept one or more alternative interactions. In such an embodiment, the system may send the information to the entity 110 such the entity 110 can begin to initiate an interaction completion process (e.g., checkout) for the user 102.

At event 404, the system may generate an interaction or transaction code based at least partially on the user choosing to the option to accept one or more alternative interactions. The interaction code may comprise information including, but not limited to, the resource(s) name, resource cost, resource manufacturer, resource make/model, resource characteristics (e.g. color, size, etc.), resource location, resource SKU number, offer discount, offer date, offer location, and the like. In another embodiment, the transaction code may include payment information associated with the user 102.

At event 406, the system may send the interaction code to the user 102. The interaction code may be sent to the user 102 by the application server 108 such that the interaction code can be view on a display associated with the users' 102 mobile device 104. The interaction code may be scanned using the reader device 135 associated with the entity system 106. In one embodiment, the interaction code may be a one-dimensional code such as a barcode. In another embodiment, the interaction code may be a two-dimensional code such as a QR code. In yet another embodiment, the interaction code may be an alphanumeric code such as a coupon code. The interaction code may be presented by the user 102 and scanned by the entity system 106 such that the interaction or transaction process is initiated in one form or another. In one embodiment, the entity system 106 may receive the user's 102 payment information along with the detail of the alternative interaction accepted upon receiving the interaction code. Scanning the interaction code, or other readable indicia, may trigger an interaction completion process between the user and the entity, wherein the interaction completion process applies and finalizes the alternative interaction accepted by the user. In one embodiment, the interaction code may be time sensitive such that it may expire within a predetermined time period. The predetermined time period may be set with respects to a specified number of minutes, hours, days, weeks, months and the like. This may discourage the user 102 from leaving the entity 110 location without completing an interaction, for example, in the same day.

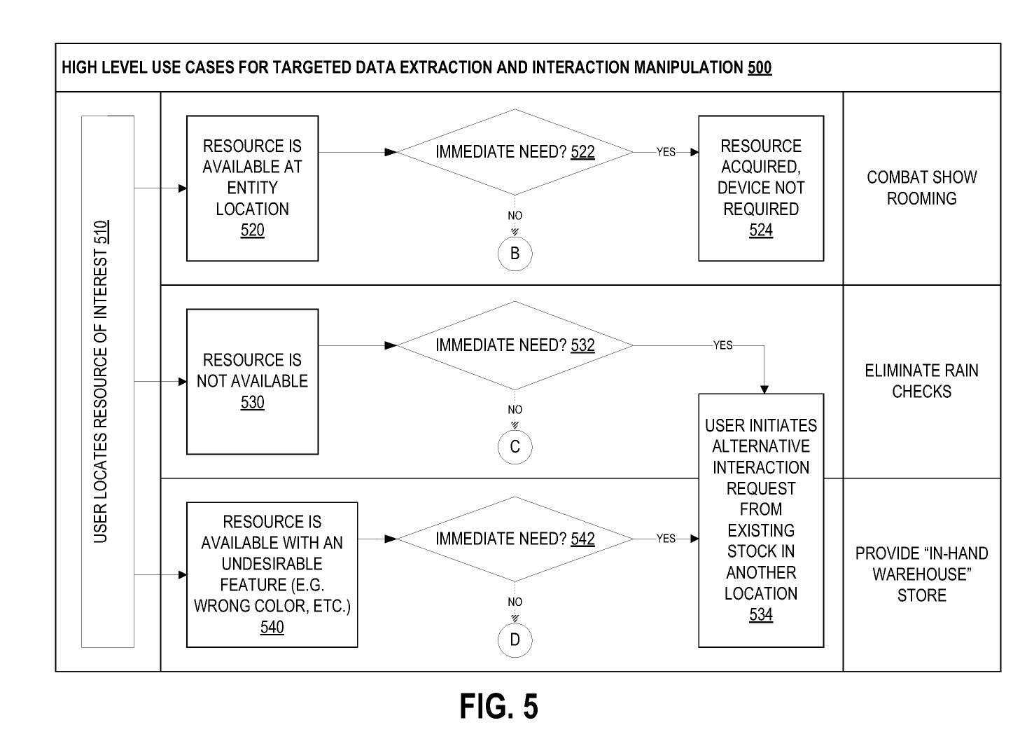

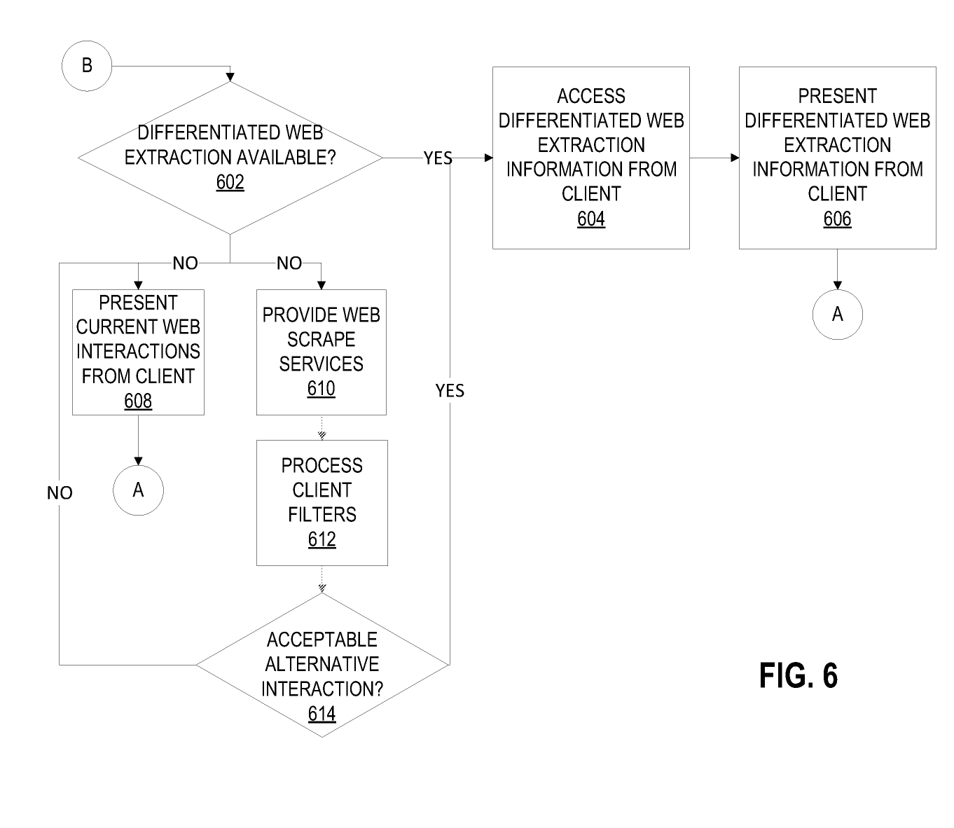

Referring now to FIG. 5, a block diagram illustrating high level use cases for targeted data extraction and interaction manipulation 500, according to an embodiment of the present invention, is provided. The system may be used in several different cases. In one embodiment, the system may be used to deter a loss of a potential interaction (i.e., show rooming) at an entity 110 location. In such an embodiment, the user 102 may locate a resource of interest 510 at the entity location. If the resource is available at the entity location 520 the user 102 may or may not have an immediate need for the resource 522. In an instance where the user 102 has an immediate need for the resource, the user 102 may purchase the resource without inquiring whether better alternative interactions exist for the resource at competitive, other entity locations, as illustrated in even 524. In an instance where the user 102 does not have an immediate need for the resource, the user 102 may inquire whether differentiated web extraction is available 602, as shown in FIG. 6, wherein competitive alternative interactions from other entities are selectively extracted from other entity systems based a value delta (e.g., a difference in pricing, offer value, distance of available resource, or the like) calculated between the interactions offered by the entity and the other, competing entities. If differentiated web extraction is available the user 102 may access the differentiated web extraction information from the system 604 such that alternative interactions available from other competitors (e.g., online competitors) are presented 606 on the user's mobile device where the user 102 may either accept or deny an alternative interaction 614 and proceed to complete an interaction with the entity. In one embodiment, if differentiated web extraction is not available, the system may present current web interactions from the client 608. In another embodiment, if differentiated web extraction is not available the system may provide web scraping services 610 and process one or more client filters 612 such that the user may either accept or deny an alternative interaction 614 and proceed to complete an interaction with the entity. In an instance that the alternative interaction is not acceptable 614 the system may present current web prices from the client 608 and allow the user 102 to proceed with processing an interaction with the entity.

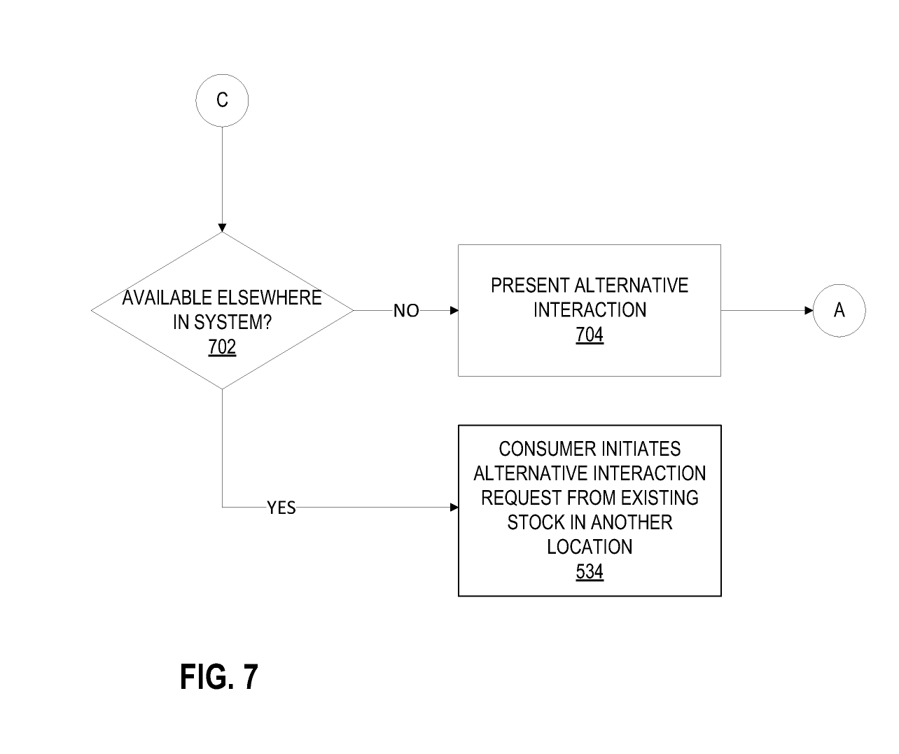

In another embodiment, the system may be used to eliminate rain checks at an entity 110 location. In such an embodiment, the user 102 may locate a resource of interest 510 at the entity location. If the resource is not available at the entity location (e.g., sold out or the like), as illustrated in event 530, the user 102 may or may not have an immediate need for the resource 532. In an instance where the user 102 has an immediate need for the resource, the user 102 may initiate an alternative interaction request from the existing resource stock in another entity location 534. In an instance where the user 102 does not have an immediate need for the resource, the user 102 may inquire whether the resource is available elsewhere in the system 702, as shown in FIG. 7. If the resource is not available, the user 102 may be presented an alternative interaction 704 by the entity 110 where the alternative interaction may include shipping the resource of interest to the user 102. The offer may include a shipment time, shipment cost, and the like such that the user 102 may either accept or deny an alternative interaction and proceed to complete an interaction with the entity 110. In one embodiment, the user 102 may be required to pay for the resource at the time of accepting the alternative interaction. In another embodiment, the user 102 may be allowed to pay for the resource at a later date. In such an embodiment, the system may trigger the resource to be shipped to the entity store and available for pick-up on the arrival date such that the user 102 may pay for the resource when it is picked up.

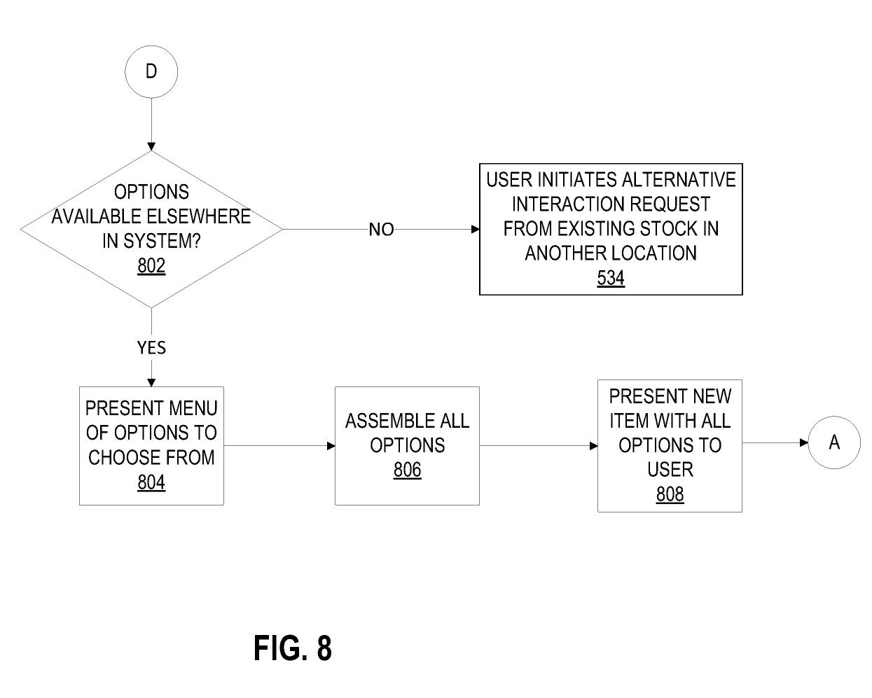

In yet another embodiment, the system may be used to provide in-hand warehousing at an entity 110 location. In such an embodiment, the user 102 may locate a resource of interest 510 at the entity location. If the resource is available at the entity location in an undesirable feature 540 the user 102 may or may not have an immediate need for the resource 542. For example the user 102 may desire a white smartphone of a specific make/model but the entity may only have a black smartphone of the specific make/model in stock. In an instance where the user 102 has an immediate need for the resource, the user 102 may trigger an alternative interaction request from the existing resource stock in another entity location 534, wherein the system triggers communication to the another entity location to flag the resource as reserved and prevent the resource from being purchased by another user in another interaction. In some embodiments, the system may cause a notification to be generated and presented to the entity notifying the entity that the resource is already involved in a preexisting interaction and to not provide the particular resource to another user in a different interaction. In some embodiments, the system may prevent the generation of an interaction code or other readable indicia associated with a reserved resource to prevent the loss of a resource already designated for a user in a preexisting interaction. In an instance where the user 102 does not have an immediate need for the resource, the user 102 may inquire whether the resource options are available elsewhere in the system 802, as shown in FIG. 8. If the resource is available the user 102 may be presented a menu of options to choose from 804. The options may then be assembled 806, and the user 102 may be presented with a new item including the assembled options 808 such that the user 102 may either accept or deny an alternative interaction and proceed to complete an interaction with the entity 110.

In another embodiment, the system may provide a process that triggers a resource (i.e., merchandise) to be shipped from an alternative entity location where the selected resource is being sold at a slower rate versus being shipped from a central resource location, such as a warehouse. As such the system may be further configured to determine one or more entity locations that have a surplus of the selected resource and determine that the resource is being sold at a slow rate. The system is capable of analyzing entity location level margin/inventory movement with respect to any given resource as criteria for determining from which location to ship resources. Based on the analysis of entity location level margins/inventory movements, with respect to a resource, the system may trigger the shipment of the resource upon the analyzed criteria meeting a predetermined threshold level or rate.

For example, the system may first determine that the selected resource is unavailable at the entity location where the user is currently located. In response to receiving, from the user, an indication of interest in the selected resource, the system may determine one or more alternative entity locations that have the resource in stock and have indicated based on inventory movement that the resource is being sold at a slower rate. The system may then determine to ship the resource to the user from at least one alternative entity location versus being shipped from a central location. In some embodiments, the user may indicate a need to purchase a plurality of the selected resource. In this instance, the system may determine to ship the resource to the user from more than one of the alternative entity locations.

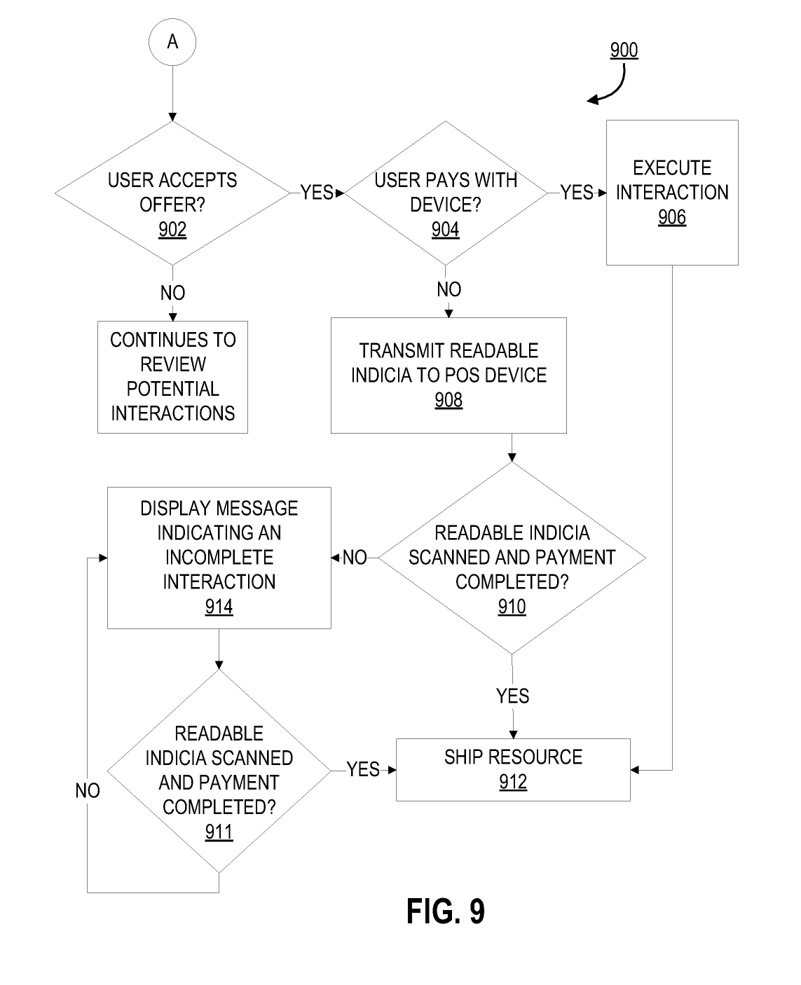

Referring now to FIG. 9, a block diagram illustrating a method for processing and completing an interaction 900, according to an embodiment of the present invention, is provided. A user 102 may first accept an alternative interaction 902. In the instance that the user 102 accepts the alternative interaction, the user 102 may complete the interaction (i.e., pay for the purchase) using the device 904 in which the alternative interaction was accepted. For example, the user 102 may be presented one or more alternative interactions on a mobile device 104 via a user application 122 such that upon accepting at least one alternative interaction the user 102 may complete the interaction for the resource of interest using the mobile device 104. If the interaction is successfully executed and completed 906, the resource may be later shipped to the user, as illustrated in event 912. In an alternative embodiment, the user 102 may immediately receive the resource once the interaction has been successfully executed 906.

In the instance that the user 102 accepts the alternative interaction, the user 102 may also choose to not complete the interaction using the device 904 in which the alternative interaction was accepted. In such an instance, readable indicia, such as a scannable code, may be sent to the point-of-sale (POS) device 908. For example, the user 102 may be presented one or more alternative interactions on a mobile device 104 via a user application 122 such that upon accepting at least one alternative interaction, readable indicia may be sent to the POS device. Upon processing the readable indicia (e.g., scanning the code) the interaction associated with the resource of interest may or may not be completed 910. If the interaction is successfully completed, the resource may be later shipped to the user 102, as illustrated in event 912. In an alternative embodiment, the user 102 may immediately receive the resource once the interaction has been successfully completed. If the interaction is not successfully completed (i.e., payment is not successful), the user 102 may be presented a message indicating the interaction is incomplete, as illustrated in event 914. For example, the user 102 may have chosen a method of payment with insufficient funds available such that the user 102 may be notified of the failed interaction and prompted to choose an alternative method of payment. The system may then again inquire whether or not the readable indicia has been processed and the interaction has been completed 911. Upon a second time, if the interaction is successfully completed, the resource may be later shipped to the user 912. In an alternative embodiment, the user 102 may immediately receive the resource once the interaction has been successfully completed. In an instance that the interaction has not been completed, the system reverts back to displaying an error message 914.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

What is claimed is:

1. An system for processing readable indicia for targeted data extraction and interaction manipulation, the system comprising:
a memory;
a computer processing device; and
a module stored in the memory, executable by the computer processing device, and configured to:
receive an alternative interaction request from a user, wherein the alternative interaction request indicates interest of the user in completing a resource exchange process for one or more resources provided by a first entity at a first entity location;
establish, over a network, one or more operative communication channels with one or more other entity systems;
extract targeted interactions from the one or more other entity systems based on the alternative interaction request from the user, wherein the targeted interactions are used to populate a database stored in the memory;
generate one or more alternative interactions based at least in part on the alternative interaction request and the targeted interactions, wherein generating the one or more alternative interactions comprises identifying, in the database stored in the memory, one or more alternative interactions associated with at least one resource indicated in the alternative interaction request;
transmit to the user the one or more alternative interactions in response to the alternative interaction request, wherein at least one of the one or more alternative interactions is related to a second entity associated with a second entity location;
generate an interactive notification for the user to select at least one alternative interaction, wherein selecting the at least one alternative interaction is equated to accepting one or more terms and conditions associated with the at least one alternative interaction; and
receive an option selection of the user.

2. The system of claim 1, wherein the module is further configured to:
establish an operative communication channel with an online entity system associated with an online entity, wherein interactions and communications between the user and the online entity are routed through the operative communication channel;
detect an in progress interaction between the user and the online entity at an online entity location associated with the online entity;
interrupt the in progress interaction before completion of the in progress interaction;
generate a composite online entity location by manipulating a presentation of the online entity location to the user by incorporating the one or more alternative interactions, wherein the composite online entity location comprises the online entity location and the one or more alternative interactions;
generate a notification within the composite online entity location presenting the one or more alternative interactions to the user for selecting an option; and
in response to receiving the option selection of the user, end the in progress interaction and navigate the user to a new entity location associated with the option selection of the user.

3. The system of claim 1, wherein the module is further configured to:
transmit the alternative interaction request to the first entity, wherein the alternative interaction request is sent in response to the user providing readable indicia associated with the one or more resources or manually inputting information associated with the one or more resources; and
transmit competitor interaction information to the first entity, wherein the competitor interaction information includes a competitor offer for the one or more resources, and wherein the competitor interaction information is associated with at least one other entity associated with at least one other entity location.

4. The system of claim 1, wherein transmitting to the user one or more alternative interactions comprises the module being further configured to:
receive a first entity alternative interaction, wherein the first entity alternative interaction is determined based at least partially on competitor interaction information, and wherein determining the first entity alternative interaction comprises determining a resource exchange amount associated with the first entity less than a resource exchange amount indicated in the competitor interaction information or determining an offer not indicated in the competitor interaction information; and
transmit the first entity alternative interaction to the user, wherein the first entity alternative interaction provides details for at least one of the resource exchange amount associated with the first entity and the offer.

5. The system of claim 1, wherein the module is further configured to:
individually display, on a mobile device associated with the user, the at least one alternative interaction such that the at least one alternative interaction is accompanied by the option to select the at least one alternative interaction.

6. The system of claim 1, wherein not selecting the at least one alternative interaction is associated with denying one or more terms and conditions associated with the at least one alternative interaction.

7. The system of claim 1, wherein the option selection of the user indicates the user denied the one or more alternative interactions, and wherein the module is further configured to:
provide at least one entity with information related to a denial of the one or more alternative interactions, wherein the at least one entity includes the first entity; and
receive a new first entity alternative interaction, wherein the first entity determines the new first entity alternative interaction based at least partially on the information related to the denial of the one or more alternative interactions such that the new first entity alternative interaction is subsequently sent to the user.

8. The system of claim 1, wherein transmitting to the user the one or more alternative interactions further comprises retrieving the one or more alternative interactions from the database stored in the memory.

9. The system of claim 1, wherein the user specifies one or more user preferences for receiving alternative interactions, and wherein the user preferences are related to pricing, location, or resource quality.

10. The system of claim 1, wherein the module is further configured to initiate an interaction completion process in response to receiving the option selection of the user.

11. The system of claim 1, wherein the module is further configured to:
generate an interaction code based at least partially on the option selection of the user; and
transmit the interaction code to the user, wherein the interaction code comprises information associated with the at least one resource and the at least one alternative interaction, and wherein the interaction code is displayed on a mobile device associated with the user.

12. The system of claim 1, wherein the alternative interaction request is received in response to the user providing readable indicia associated with the one or more resources, wherein providing the readable indicia comprises scanning, using a mobile device, a form of visual indicia associated with the one or more resources or manually inputting information associated with the one or more resources.

13. A computer-implemented method for processing readable indicia for targeted data extraction and interaction manipulation, the computer-implemented method comprising:
receiving an alternative interaction request from a user, wherein the alternative interaction request indicates interest of the user in completing a resource exchange process for one or more resources provided by a first entity at a first entity location;
establishing, over a network, one or more operative communication channels with one or more other entity systems;
extracting targeted interactions from the one or more other entity systems based on the alternative interaction request from the user, wherein the targeted interactions are used to populate a database stored in the memory;
generating one or more alternative interactions based at least in part on the alternative interaction request and the targeted interactions, wherein generating the one or more alternative interactions comprises identifying, in the database stored in the memory, one or more alternative interactions associated with at least one resource indicated in the alternative interaction request;
transmitting to the user the one or more alternative interactions in response to the alternative interaction request, wherein at least one of the one or more alternative interactions is related to a second entity associated with a second entity location;
generating an interactive notification for the user to select at least one alternative interaction, wherein selecting the at least one alternative interaction is equated to accepting one or more terms and conditions associated with the at least one alternative interaction; and
receiving an option selection of the user.

14. The computer-implemented method of claim 13, the method further comprising:
transmitting the alternative interaction request to the first entity, wherein the alternative interaction request is sent in response to the user providing readable indicia associated with the one or more resources or manually inputting information associated with the one or more resources; and
transmitting competitor interaction information to the first entity, wherein the competitor interaction information includes a competitor offer for the one or more resources, and wherein the competitor interaction information is associated with at least one other entity associated with at least one other entity location.

15. The computer-implemented method of claim 13, wherein transmitting to the user one or more alternative interactions further comprises:
receiving a first entity alternative interaction, wherein the first entity alternative interaction is determined based at least partially on competitor interaction information, and wherein determining the first entity alternative interaction comprises determining a resource exchange amount associated with the first entity less than a resource exchange amount indicated in the competitor interaction information or determining an offer not indicated in the competitor interaction information; and
transmitting the first entity alternative interaction to the user, wherein the first entity alternative interaction provides details for at least one of the resource exchange amount associated with the first entity and the offer.

16. The computer-implemented method of claim 13, the method further comprising:
generating an interaction code based at least partially on the option selection of the user; and
transmitting the interaction code to the user, wherein the interaction code comprises information associated with the at least one resource and the at least one alternative interaction, and wherein the interaction code is displayed on a mobile device associated with the user.

17. A computer program product for processing readable indicia for targeted data extraction and interaction manipulation, the computer program product comprising:
a non-transitory computer-readable medium comprising a set of codes for causing a computer to:
receive an alternative interaction request from a user, wherein the alternative interaction request indicates interest of the user in completing a resource exchange process for one or more resources provided by a first entity at a first entity location;
establish, over a network, one or more operative communication channels with one or more other entity systems;
extract target interactions from the one or more other entity systems based on the alternative interaction request from the user, wherein the targeted interactions are used to populate a data based stored in the memory;
generate one or more alternative interactions based at least in part on the alternative interaction request and the targeted interactions, wherein generating the one or more alternative interactions comprises identifying, in the database stored in the memory, one or more alternative interactions associated with at least one resource indicated in the alternative interaction request;
transmit the user the one or more alternative interactions in response to the alternative interaction request, wherein at least one of the one or more alternative interactions is related to a second entity associated with a second entity location;
generate an interaction notification for the user to select at least one alternative interaction, wherein selecting the at least one alternative interaction is equated to accepting one or more terms and conditions associated with the at least one alternative interaction; and
receive an option selection of the user.

18. The computer program product of claim 17, further comprising a set of codes for causing a computer to:
transmit the alternative interaction request to the first entity, wherein the alternative interaction request is sent in response to the user providing readable indicia associated with the one or more resources or manually inputting information associated with the one or more resources; and
transmit competitor interaction information to the first entity, wherein the competitor interaction information includes a competitor offer for the one or more resources, and wherein the competitor interaction information is associated with at least one other entity associated with at least one other entity location.

19. The computer program product of claim 17, further comprising a set of codes for causing a computer to:
receive a first entity alternative interaction, wherein the first entity alternative interaction is determined based at least partially on competitor interaction information, and wherein determining the first entity alternative interaction comprises determining a resource exchange amount associated with the first entity less than a resource exchange amount indicated in the competitor interaction information or determining an offer not indicated in the competitor interaction information; and
transmit the first entity alternative interaction to the user, wherein the first entity alternative interaction provides details for at least one of the resource exchange amount associated with the first entity and the offer.

20. The computer program product of claim 17, further comprising a set of codes for causing a computer to:
generate an interaction code based at least partially on the option selection of the user; and
transmit the interaction code to the user, wherein the interaction code comprises information associated with the at least one resource and the at least one alternative interaction, and wherein the interaction code is displayed on a mobile device associated with the user.
